(19) United States
(12) Patent Application Publication
(10) Pub. No.: US 2018/0280900 A1
(43) Pub. Date: Oct. 4, 2018

(54) Fluid Mixing Device

(71) Applicant: Fives Landis Limited, Keighley (GB)

(72) Inventor: Matthew J. Tucker, Keighley (GB)

(21) Appl. No.: 15/677,424

(22) Filed: Aug. 15, 2017

(30) Foreign Application Priority Data
Mar. 31, 2017 (GB) 1705200.2

(51) Int. Cl. B01F 5/06

(52) U.S. Cl. CPC B01F 5/0617; B01F 2005/0639; B01F 2005/0629; B01F 5/0614

(57) ABSTRACT

A fluid mixing device comprises a tubular structure including an inner wall which defines a channel, and a plurality of flow deflection elements which are supported by the structure and located within the channel. Each flow deflection element defines a surface that extends between a first leading edge, which extends transversely around a first portion of the inner wall of the hollow tubular structure, and a first trailing edge which is spaced in a longitudinal direction from the first leading edge and extends radially inwardly from the inner wall. Such a device may be used on a large scale, for example in industrial systems, and also on a smaller scale, such as in microfluidic systems for biological and chemical analysis.

### CROSS-REFERENCE TO RELATED APPLICATION

The present application claims priority under 35 U.S.C. § 119 of United Kingdom Patent Application No. 1705200.2, filed Mar. 31, 2017, the disclosure of which is hereby incorporated herein by reference in its entirety.

### FIELD OF THE INVENTION

The present disclosure concerns a fluid mixing device and more particularly it relates to devices for increasing the homogeneity of a fluid, mixing together dissimilar fluids, or for minimizing thermal gradients across a fluid stream. Such a device may be used on a large scale, for example in industrial systems, and also on a smaller scale, such as in microfluidic systems for biological and chemical analysis.

### BACKGROUND OF THE INVENTION

Precision and ultra-precision machine tools commonly incorporate hydrostatic guideways and spindle bearings to ensure that the structural loop supporting the machining process is optimized to be highly stiff and well damped. Specialist hydrostatic fluid delivery equipment built for use in such machines must minimize audible noise and transmitted vibrations from its pumps and fluid flow, to avoid disturbing the machine structure and causing damage to the surface integrity of the workpiece. Fluid mass flow rate is deliberately kept low in such equipment, with pipes and restrictors designed to ensure laminar flow with minimal turbulence. However, low turbulence leads to poor thermal mixing of the fluid and this can make it more difficult to maintain accurate temperature control of the machine, which can reduce the dimensional accuracy of the machining process.

Fluid delivery equipment may use temperature feedback control linked to fast acting heaters to trim the temperature of a pressurized hydraulic fluid at the point of delivery of the fluid to the machine tool. The heater elements are located in chambers where the oil is caused to flow chaotically around the elements. Whilst this chaotic motion of the fluid in the chambers improves the heat mixing, it is at the expense of turbulent flow and a consequent increase in background noise and vibration.

It is desirable to accurately measure the temperature of the fluid close to the point of use in the machine tool. However, there tends to be a temperature gradient across the pipework in the fluid delivery system so it is not possible to accurately assess the overall temperature of the fluid using a single sample point. Multi-point temperature sampling may be used, but is complex and not guaranteed to produce consistent results.

Various devices have been developed to cause dissimilar fluids to be combined involving labyrinthine pipework, grids and pocketed structures, for example. However, many existing devices tend to cause eddy currents and turbulent flow to develop, and provide an inadequate degree of mixing.

### SUMMARY OF THE INVENTION

The present disclosure provides a fluid mixing device comprising a tubular structure including an inner wall which defines a channel, the channel having a central longitudinal axis and being configured to convey a fluid in a longitudinal direction along the structure; and a plurality of flow deflection elements which are supported by the structure and located within the channel, with each flow deflection element defining a surface that extends between a first leading edge, which extends transversely around a first portion of the inner wall of the hollow tubular structure, and a first trailing edge which is spaced in the longitudinal direction from the first leading edge and extends radially inwardly from the inner wall.

The configuration of the flow deflection elements tends to direct fluid flowing close to the inner wall of the tubular structure away from the wall and preferably generally towards the center of the channel. At the same time, it rotates the fluid flowing over the elements relative to the longitudinal direction. Improved mixing may be achieved without causing excessive turbulence using such arrangements. The mixing device may cause heat energy within the fluid to be substantially evenly distributed across a transverse cross-section of the flow before the fluid exits the device.

The flow deflection elements may be arranged such that the cross-sectional area through which the fluid flows as it passes over the fluid deflection elements remains substantially constant. This minimizes changes in the flow velocity which might otherwise tend to increase turbulence.

The mixing device may be configured to divide and recombine the fluid flow multiple times. The shape of the fluid deflection elements may tend to cause the fluid flow to be both rotated and carried through cross-sections of different shapes to enhance the mixing process.

The leading edges may extend around a portion of the inner wall of the tubular structure in a plane perpendicular to the central longitudinal axis.

The flow deflection elements may be supported at fixed locations within the device by the tubular structure. They may be supported along their leading and/or trailing edges.

In a preferred example, the first trailing edge of each of the plurality of flow deflection elements extends radially inwardly from a point on the inner wall which is substantially aligned in the longitudinal direction with one end of the first trailing edge. This may tend to lead to smoother flow of the fluid after the deflection element.

A gradient of the surface of each of the plurality of flow deflection elements, with respect to the longitudinal direction and in a plane which includes the central longitudinal axis, may increase and then decrease from the first leading edge to the first trailing edge. Such a profile may tend to increase the rate of mixing whilst maintaining smooth fluid flow.

In preferred examples, the rate of change of a gradient of the surface of each flow deflection element, with respect to the longitudinal direction and in a plane which includes the central longitudinal axis, from the first leading edge to the first trailing edge:

(a) increases to a maximum, positive value;
(b) then decreases to a minimum negative value; and
(c) then increases again.

Preferably, a gradient of the surface of each of the plurality of flow deflection elements, with respect to the longitudinal direction and in a plane which includes the central longitudinal axis, is substantially zero at the first leading edge and the first trailing edge. This serves to minimize disturbance of smooth fluid flow by the fluid deflection elements.

In preferred configurations, each of the plurality of flow deflection elements is (preferred substantially) confined transversely between radially inwardly extending lines (preferably straight) which extend from each end of the first leading edge towards the central axis. This facilitates combination of the elements in such a way as to ensure thorough mixing of the fluid without excessively impeding the fluid flow, by arranging a sequence of elements so that their respective radially inwardly extending lines are substantially aligned in the longitudinal direction, with the elements in combination extending substantially over the entire cross-section of the channel when viewed in the longitudinal direction.

For example, the radially extending lines may subtend an angle at the central longitudinal axis of around 90°. In that case, it can be seen that four elements are able in combination to impinge on the fluid flow across the whole cross-section of the channel.

Preferably, each of the plurality of flow deflection elements is paired with another flow deflection element that extends between a second leading edge, which extends transversely around a second portion of the inner wall of the hollow tubular structure, and a second trailing edge which is spaced in the longitudinal direction from the first leading edge and extends radially inwardly from the inner wall, with the second leading edge and second trailing edge being substantially diametrically opposite to the first leading edge and the first trailing edge, respectively. Two or more such pairs may be provided at substantially the same longitudinal locations in the structure with each pair being rotationally displaced (from the others) relative to the central longitudinal axis. Multiple pairs may be provided which are spaced longitudinally along the tubular structure, with adjacent pairs being rotationally displaced from one another relative to the central longitudinal axis.

The device may include a supporting plate which extends diametrically across the channel and parallel to the central axis and provides support for a respective pair of diametrically opposed flow deflection elements.

In a preferred example, a pair of flow deflection elements which acts to deflect flow in a clockwise sense around the central longitudinal axis is located upstream of a further pair of flow deflection elements which acts to deflect flow in an anti-clockwise sense around the central longitudinal axis, or vice versa. Reversing the direction of rotation imposed on the fluid by the flow deflection elements tends to enhance the mixing effect.

More preferably, a sequence of four consecutive pairs of flow deflection elements in the longitudinal direction acts to deflect flow around the central longitudinal axis in a clockwise sense, a clockwise sense, an anti-clockwise sense, and an anti-clockwise sense, respectively, or vice versa. It has been found that such a combination of elements is particularly effective for mixing.

A set of two longitudinal spaced apart pairs of flow deflection elements which acts to deflect flow in the same rotational sense may be provided. They may be configured such that all fluid around the circumference of the channel impinges on at least one of the flow deflection elements so as to avoid any fluid travelling adjacent to the wall of the channel and being substantially undisturbed by the deflection elements.

A fluid mixing device exemplifying the present disclosure may comprise a multiplicity of groups of flow deflection elements, each group comprising four elements spaced consecutively along the structure in the longitudinal direction, with the groups provided in series to iteratively improve the uniformity of mixing of the fluid flow along the device. Each group may comprise a set of four pairs of flow deflection elements as defined above.

A fluid mixing device as described herein may be included in a fluid delivery system for a machine tool. The present disclosure further provides a machine tool including such a fluid delivery system.

For some applications, the fluid mixing device may be provided within a bore of a tube, for example a pressure resistant tube such as a hydraulic pipe. This may serve to increase the burst pressure of the device, and may therefore be desirable in high pressure systems. Fabrication of the fluid mixing device may involve 3D printing techniques.

The fluid mixing device may be used to minimize thermal gradients across fluid streams. It may also be used to mix dissimilar fluids, which may be in the form of liquids, aerosols or gases.

### BRIEF DESCRIPTION OF THE DRAWINGS

A known fluid mixing device and examples of the disclosure will now be described with reference to the accompanying schematic drawings, wherein:

FIG. 1 is a perspective view of sections of a fluid mixing device configuration which is outside the scope of the present disclosure;

FIG. 2 is a perspective view of a section of a fluid mixing device according to an example of the disclosure;

FIGS. 3 to 7 are perspective, top, front, side and rear views of part of a device section similar to that shown in FIG. 2;

FIG. 8 is a plot to illustrate a profile of a flow deflection element in the example of FIGS. 2 to 7;

FIG. 9 is a perspective exploded view of a sequence of sections of a fluid mixing device according to an example of the disclosure;

FIG. 10 depicts the results of a simulation based on the known mixing device configuration of FIG. 1;

FIG. 11 is a depiction of a simulation based on a fluid mixing device using sections of the configuration shown in FIGS. 2 to 7; and

FIG. 12 shows plots of temperature gradients generated by the simulations of FIGS. 10 and 11.

### DETAILED DESCRIPTION OF THE INVENTION

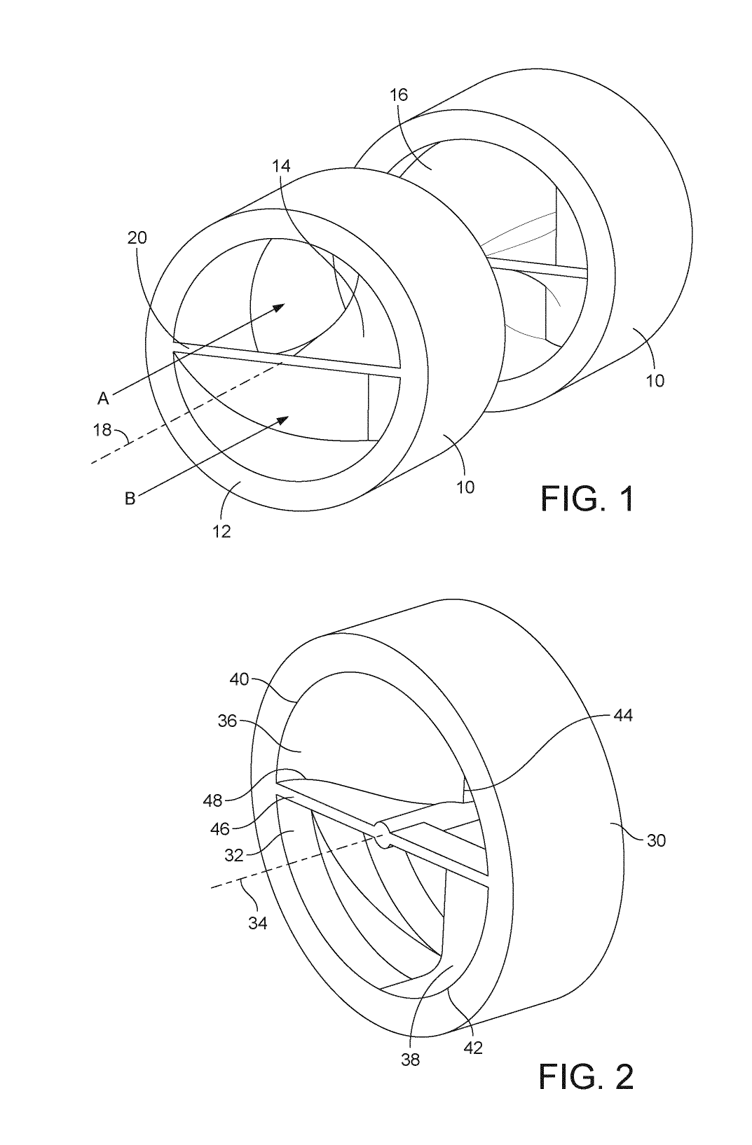

FIG. 1 shows two sections of a fluid mixing device outside the scope of the present disclosure which has a configuration similar to that disclosed in U.S. Pat. No. 3,286,992. This document relates to a device for mixing two or more fluid feed materials and dispensing the resulting composition.

The device of FIG. 1 includes a hollow cylindrical tube 10 of uniform cross-section. This tube has been divided transversely into two parts in FIG. 1 so that the internal structure is more clearly visible. In use, two feed liquids A and B may be fed via feed end 12 through the tube 10.

Two curved elements 14 and 16 are provided within the tube in sequence along the axial direction. Each curved element is formed from a thin flat sheet which has been twisted about the central axis 18 of the tube so that upstream and downstream edges of the tube are at a substantial angle to each other. Curved element 16 is located downstream of element 14. Curved element 14 twists in the opposite rotational direction to element 16.

The initial stream consisting of components A and B strikes the upstream edge 20 of the first curved element 14 which splits it into two partial streams. The curved elements rotate the flows helically in one direction and then the other.

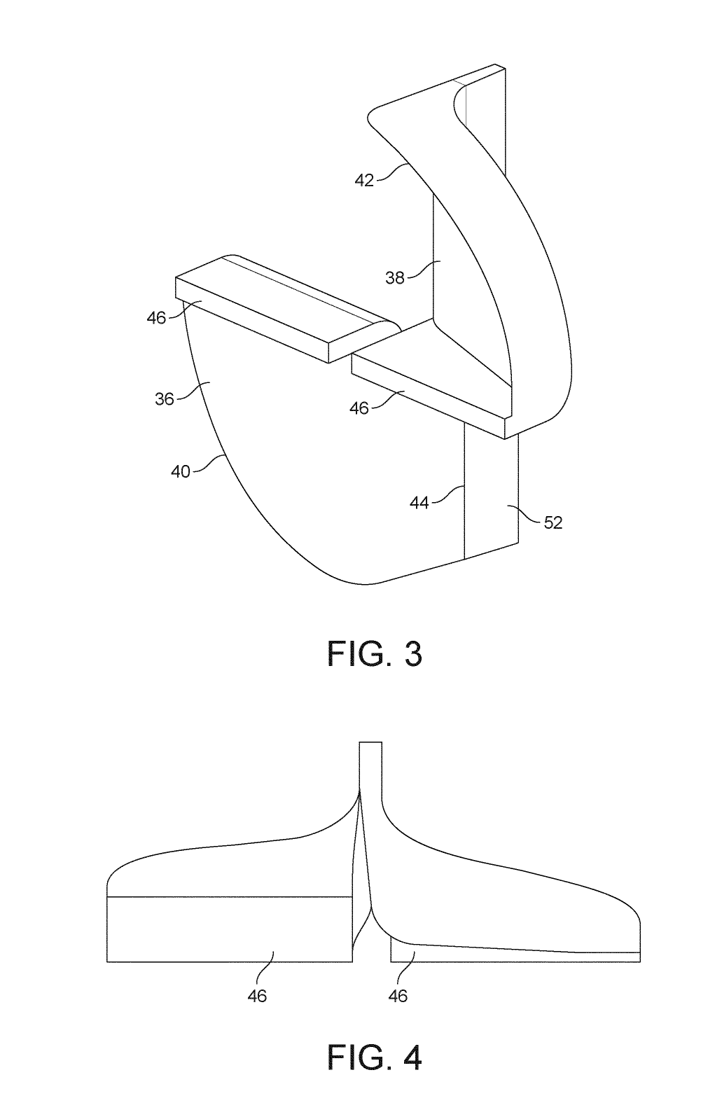

A section of a fluid mixing device is shown in FIG. 2 as an example according to the present disclosure. It includes a hollow tubular structure 30 having an inner cylindrical wall 32 which defines a channel having a central longitudinal axis 34. A pair of flow deflection elements 36 and 38 is provided within the channel at substantially the same axial location. Flow deflection element 38 is the same shape as flow deflection element 36, but it is rotated through 180° about the central axis of the tubular structure relative to element 36.

Each flow deflection element has a leading edge 40, 42, respectively, which extends transversely, part way around the inner wall 32. Each flow deflection element also has a trailing edge (part of trailing edge 44 of one of the flow deflection elements is visible in FIG. 2) which is spaced axially from its leading edge. Each flow deflection element 36, 38 defines a curved surface that extends between its leading and trailing edges for deflecting fluid flowing towards it along the channel. Each trailing edge extends radially inwardly from the inner wall towards the central axis 34 of the tubular structure 30.

A supporting plate 46 extends diametrically across the tube between opposing parts of the inner wall and extends axially along the tubular structure.

The leading edge of each flow deflection element is supported by the inner wall of the tubular structure. The element meets the supporting plate 46 along a radially and longitudinally extending edge 48 which extends between the leading edge and the trailing edge of the deflection element. The trailing edge 44 extends radially between the inner wall of the tubular structure and the supporting plate 46. In the example illustrated, the radially extending edges 44 and 48 subtend an angle of around 90° at the central axis 34 (when projected onto a plane which is perpendicular to the central axis).

The deflection elements 36 and 38 are located at diametrically opposite positions, on opposite sides of central axis 34.

In the example illustrated in FIG. 2, the flow deflection elements are each configured to rotate fluid flow in a clockwise direction from their leading to trailing edges, when viewed in the direction of fluid flow. As the elements extend inwardly from leading edges which are located on the inner wall of the tubular structure, the deflection elements also tend to divert fluid flowing close to the inner wall radially inwardly. The flow deflection elements are able to do this without causing excessive internal turbulence. In comparison to the configuration shown in FIG. 1, this tends to encourage greater mixing of the fluids. It was found that when using an arrangement of the form shown in FIG. 1, there was a tendency for fluids to be able to travel largely undisturbed in the region proximate to the inner wall of the hollow cylindrical tube 10.

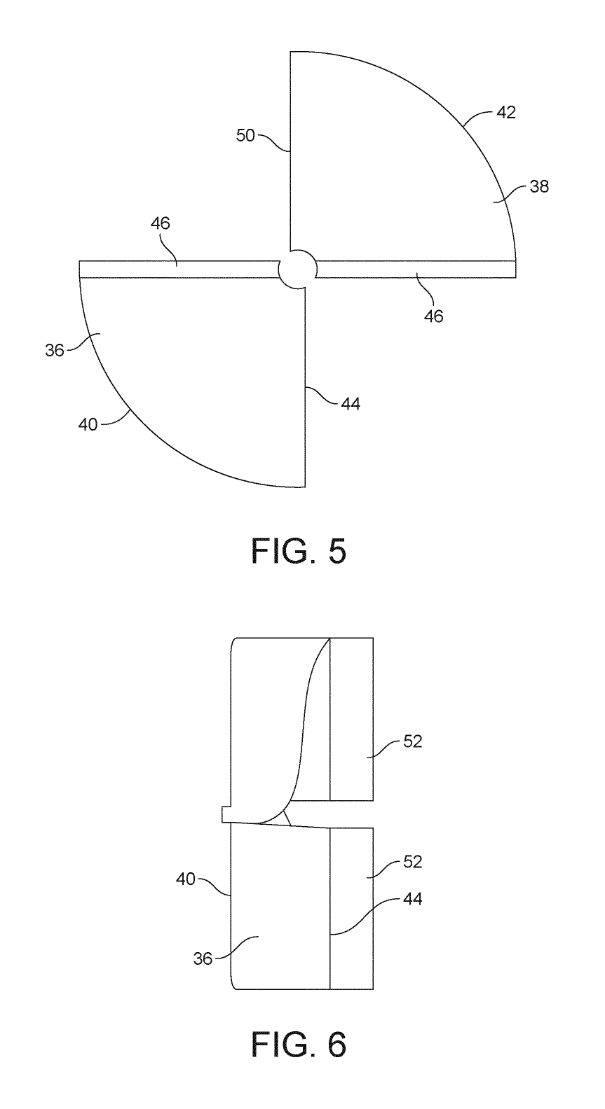

FIGS. 3 to 7 show perspective, top, front, side and rear views of flow deflection elements similar to that depicted in FIG. 2, with the tubular structure 30 omitted. The structure of FIGS. 3 to 7 differs from that shown in FIG. 2 in that the flow deflection elements are configured to rotate flow in the opposite sense, that is, in an anti-clockwise direction when viewed in the direction of fluid flow. The same reference numerals are used to identify corresponding features in each configuration.

The trailing edge 50 of flow defection element 38 is visible in FIG. 5. The trailing edges 44, 50 of the flow deflection elements meet radially extending supporting plates 52.

The flow deflection elements are configured such that the cross-sectional area through which the fluid flows is substantially constant and does not vary significantly as the fluid passes over the flow deflection elements and is rotated.

The inner diameter of the hollow tubular structure (that is, the width of the channel defined between opposite sides of its inner wall) may be selected to optimize the degree of fluid mixing for a given fluid (with the fluid deflection elements being scaled accordingly). For example, when mixing oil for use in a machine tool to minimize any temperature variations, it was found that a preferred diameter was around 20 mm. The wall thickness of such configuration may be around 5 mm to give sufficient structural strength for example. It was found that a required level of mixing was achieved using a fluid mixing device having a hollow tubular structure around 205 mm long (which included 8 pairs of flow deflection elements). It will be appreciated that further pairs of flow deflection elements may be added (or pairs removed) to attain a desired level of mixing, whilst minimizing the overall length of the device. In this example, the axial length of each module comprising a pair of flow deflection elements was around 20 mm.

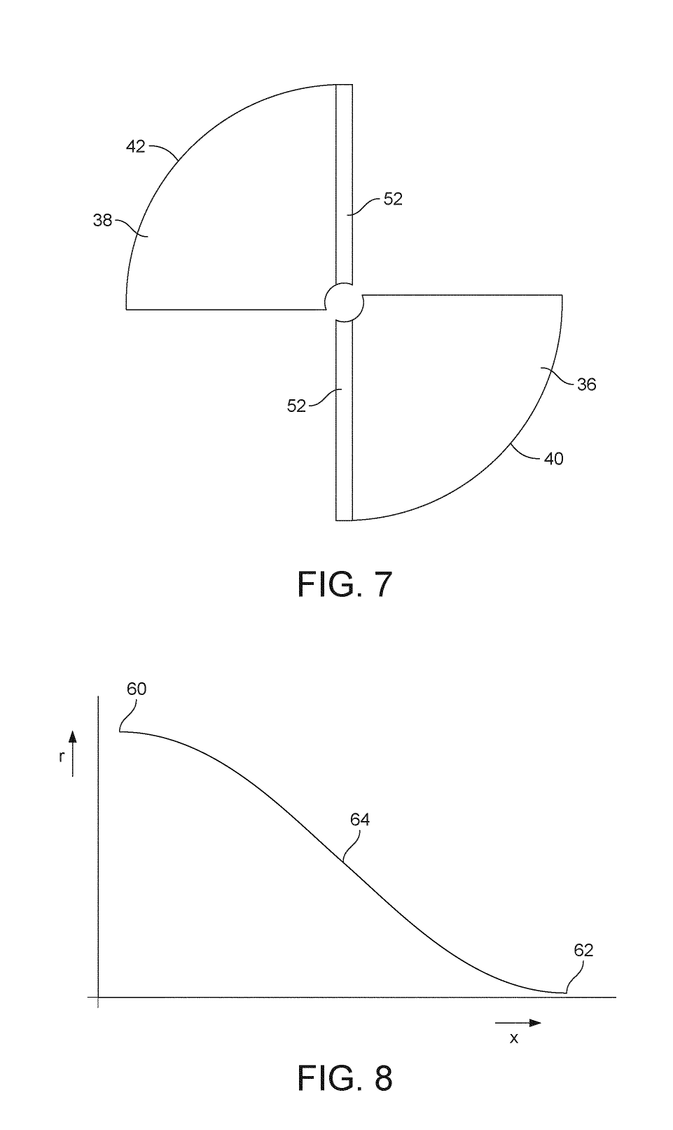

FIG. 8 shows a plot of the shape of edge 48 of a fluid deflection element in an example embodying the disclosure. The distance, r, of the edge measured radially outwardly from the central axis 34 is plotted against the distance, x, measured along the central axis 34. It can be seen that the gradient of the plot is substantially zero at the start and end points 60, 62 of the edge. This is to minimize disturbance of the flow as it impinges on and then leaves the surface of the flow deflection element. Moving along the edge from the start point 60, the gradient gradually increases to a maximum at a midpoint 64, before gradually decreasing back to at or near zero at point 62. Smooth flow over the flow deflection element is also encouraged by gradually changing the rate of change of the gradient from the start point 60 at the leading edge to the end point 62 at the trailing edge. In this direction, the rate of change of the gradient increases to a maximum, positive value, then decreases to zero at the midpoint 64, before it decreases to a minimum negative value and increases again before the end point 62 where it is again zero.

In examples of the disclosure, mixing device sections as depicted in FIG. 2 which impart a clockwise rotation to the fluid (and the counterpart sections which impart an anti-clockwise rotation) may be combined in various ways along the mixing device. It may be preferable to have groups of two or more sections which rotate in the same sense followed by two or more sections which rotate in the opposite sense. In the example depicted in the Figures, each flow deflection element of each pair subtends an angle of around 90° at the central axis. Thus, following such a section by an identical section which is rotated through 90° results in providing four flow deflection elements which together impinge on the full cross-sectional area of the channel.

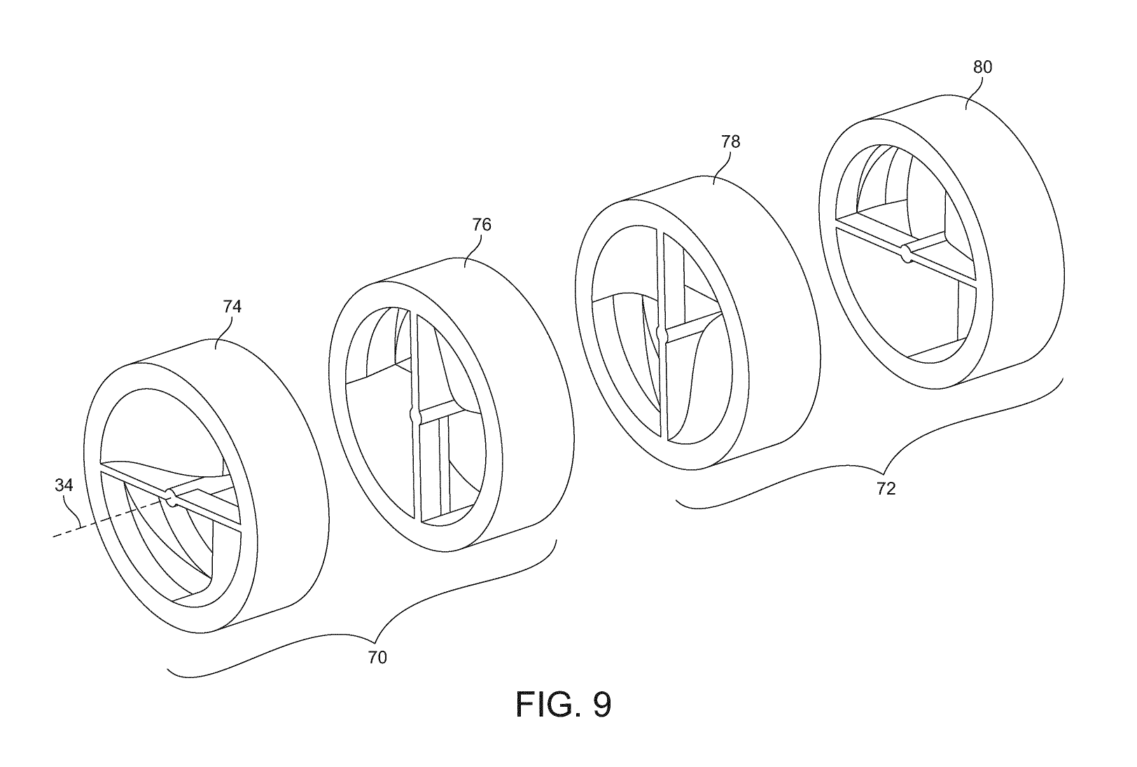

FIG. 9 depicts an exploded view of a preferred example in which a pair 70 of sections (74, 76) which rotate the flow in a clockwise sense is followed by a pair 72 of sections (78, 80) which rotate the flow in an anti-clockwise sense. The second section 76 is identical to first section 74, but is rotated 90° clockwise about the central axis 34. The fourth section 80 is identical to the third section 78, but rotated 90° anti-clockwise when looking along the direction of flow.

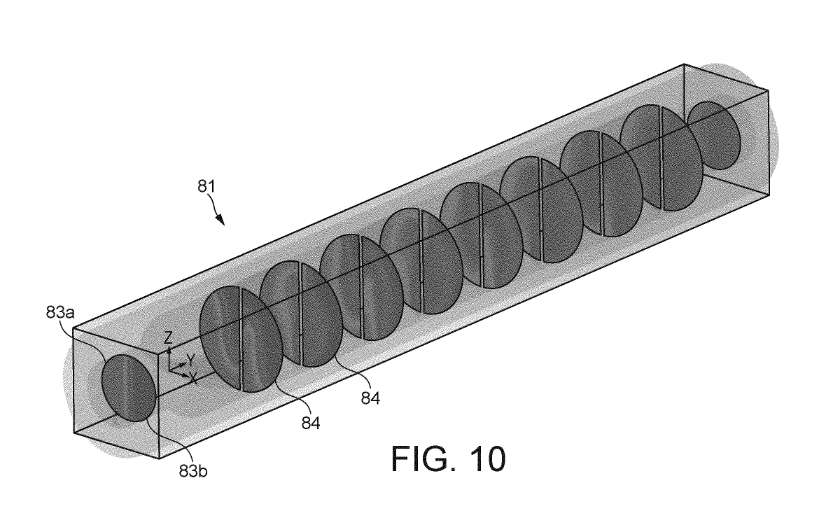

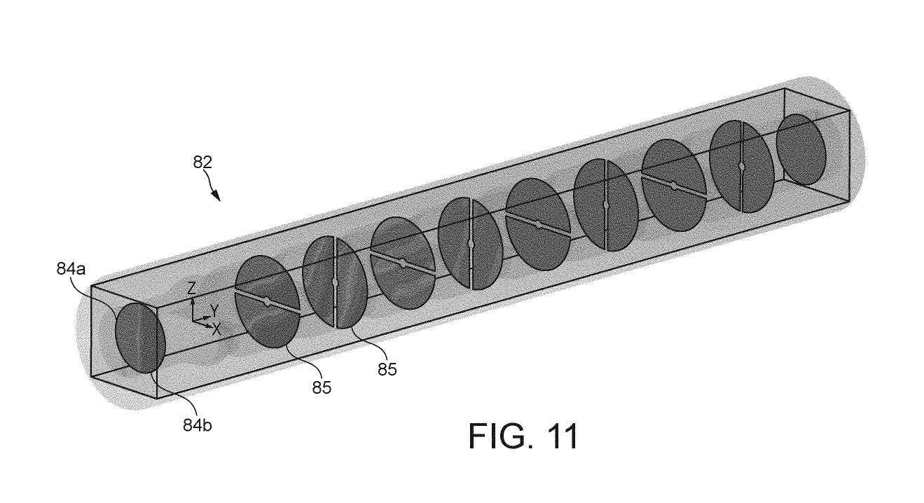

In order to compare the performance of a mixing device embodying the present disclosure with a device having a configuration of the form shown in FIG. 1, simulations were carried out using computational fluid dynamics (CFD) and the results are depicted in FIGS. 10 and 11. FIG. 10 relates to a device 81 of the form depicted in FIG. 1 and FIG. 11 relates to a device 82 according to an example of the disclosure. In each case, a flow consisting of a combination of two parts (having semi-circular cross-sections and labelled 83a, 83b and 84a, 84b, respectively) at different temperatures was fed into the input end of each device. It will be appreciated that this is an extreme “worst case scenario”, whereas in reality, the fluid will always already be in a partially mixed state, with the transition to an acceptable level of mixing happening sooner within the mixer than in these simulated examples.

In these examples, the left hand, more lightly shaded semi-circular flows (83a and 84a) were at 293.70° C. initially and the right hand, darker semi-circular flows (83b and 84b) were at 292.70° C. Cross-sections (84 and 85, respectively) of the fluid flows are shown downstream of each of eight flow mixing portions (not shown) which are provided within each device. Each cross-section is shaded according to the temperature at each point across the flow.

In the device of FIG. 10, each flow mixing portion includes a curved element of the form shown in FIG. 1 (in which the curved elements are numbered 14 and 16), with the direction of twist of each element alternating along the length of the tube. In the device of FIG. 11, each flow mixing portion comprises of a pair of sections of the form shown in FIG. 9 (in which the pairs are numbered 70 and 72), with the direction of fluid rotation caused by each pair alternating along the length of the device.

It can be seen that thorough mixing of the fluid occurs much more quickly in the example 82 of the disclosure shown in FIG. 11 compared to the device 81 of FIG. 10. In the device of FIG. 11, regions of clearly different temperature are no longer discernible after just three mixing portions, whereas, in the device of FIG. 10, temperature differences can still be seen after all eight mixing portions. According to the simulations, there was still a temperature spread of 0.4° C. at the downstream end of the device of FIG. 10, whereas any temperature spread remaining in the device of FIG. 11 was less than 0.01° C.

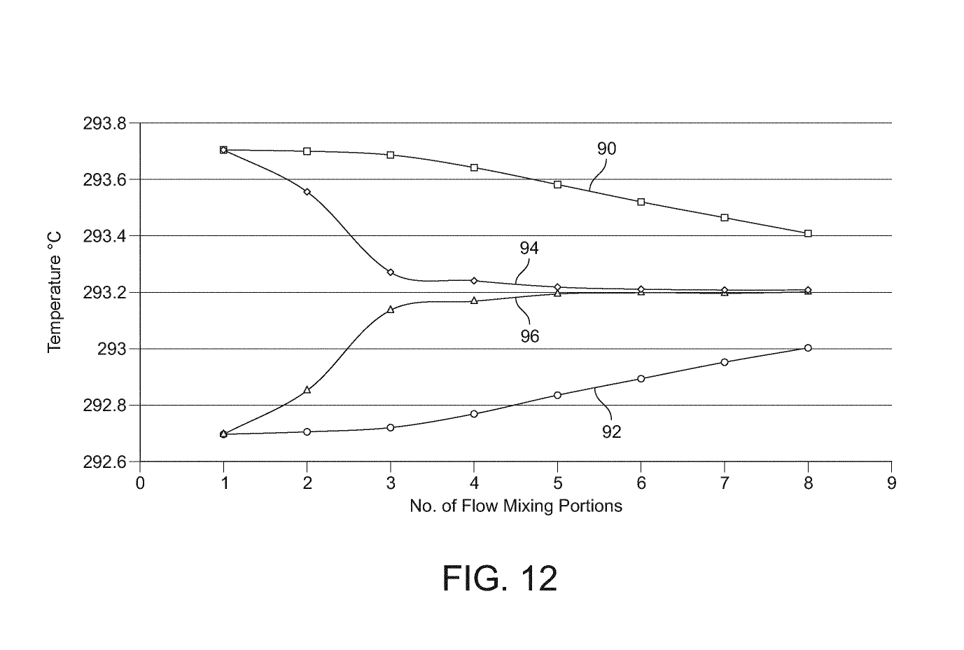

The improved performance achieved using a device according to an example of the present disclosure is further illustrated by the diagram in FIG. 12, which corresponds to the simulations shown in FIGS. 10 and 11. It shows plots of fluid temperature against axial distance along each fluid mixing device, with data points after each of the eight flow mixing portions. Plots 90 and 92 are the maximum and minimum temperatures in the device of FIG. 10, whilst plots 94 and 96 are the maximum and minimum temperatures in the device of FIG. 11 exemplifying the present disclosure. It can be seen that the temperature range decreases much more rapidly in the device of FIG. 11.

A fluid mixing device of the present disclosure may be constructed using 3D printing methods for example. This facilitates accurate construction of the desired structural elements. A wide range of plastics are suitable for use in 3D printing techniques. A device for use in a hydraulic fluid system should be resistant to degradation in the presence of oils, and could be formed from nylon for example.

While the present invention has been illustrated by description of various embodiments and while those embodiments have been described in considerable detail, it is not the intention of Applicant to restrict or in any way limit the scope of the appended claims to such details. Additional advantages and modifications will readily appear to those skilled in the art. The present invention in its broader aspects is therefore not limited to the specific details and illustrative examples shown and described. Accordingly, departures may be made from such details without departing from the spirit or scope of Applicant's invention.

What is claimed is:

1. A fluid mixing device comprising:
a tubular structure including an inner wall which defines a channel, the channel having a central longitudinal axis and being configured to convey a fluid in a longitudinal direction along the structure; and
a plurality of flow deflection elements which are supported by the structure and located within the channel,
with each flow deflection element defining a surface that extends between a first leading edge, which extends transversely around a first portion of the inner wall of the hollow tubular structure, and a first trailing edge which is spaced in the longitudinal direction from the first leading edge and extends radially inwardly from the inner wall.

2. The device of claim 1, wherein the first trailing edge extends radially inwardly from a point on the inner wall which is substantially aligned in the longitudinal direction with one end of the first trailing edge.

3. The device of claim 1, wherein a gradient of the surface of each flow deflection element, with respect to the longitudinal direction and in a plane which includes the central longitudinal axis, increases and then decreases from the first leading edge to the first trailing edge.

4. The device of claim 1, wherein the rate of change of a gradient of the surface of each flow deflection element, with respect to the longitudinal direction and in a plane which includes the central longitudinal axis, from the first leading edge to the first trailing edge:
(a) increases to a maximum, positive value;
(b) then decreases to a minimum negative value; and
(c) then increases again.

5. The device of claim 1, wherein a gradient of the surface of each flow deflection element, with respect to the longitudinal direction and in a plane which includes the central longitudinal axis, is substantially zero at the first leading edge and the first trailing edge.

6. The device of claim 1, wherein each flow deflection element is substantially confined transversely between radially inwardly extending lines which extend from each end of the first leading edge.

7. The device of claim 6, wherein the radially extending lines subtend an angle at the central longitudinal axis of around 90°.

8. The device of claim 7, wherein a pair of flow deflection elements which acts to deflect flow in a clockwise sense around the central longitudinal axis is located upstream of a further pair of flow deflection elements which acts to deflect flow in an anti-clockwise sense around the central longitudinal axis, or vice versa.

9. The device of claim 8, wherein a sequence of four consecutive pairs of flow deflection elements in the longitudinal direction acts to deflect flow around the central longitudinal axis in a clockwise sense, a clockwise sense, an anti-clockwise sense, and an anti-clockwise sense, respectively, or vice versa.

10. The device of claim 1, wherein each flow deflection element is paired with another flow deflection element that extends between a second leading edge, which extends transversely around a second portion of the inner wall of the hollow tubular structure, and a second trailing edge which is spaced in the longitudinal direction from the first leading edge and extends radially inwardly from the inner wall, with the second leading edge and second trailing edge being substantially diametrically opposite to the first leading edge and the second trailing edge, respectively.

11. The device of claim 10, wherein a pair of flow deflection elements which acts to deflect flow in a clockwise sense around the central longitudinal axis is located upstream of a further pair of flow deflection elements which acts to deflect flow in an anti-clockwise sense around the central longitudinal axis, or vice versa.

12. The device of claim 11, wherein a sequence of four consecutive pairs of flow deflection elements in the longitudinal direction acts to deflect flow around the central longitudinal axis in a clockwise sense, a clockwise sense, an anti-clockwise sense, and an anti-clockwise sense, respectively, or vice versa.

13. A fluid delivery system for a machine tool, which system includes the fluid mixing device of claim 1.

14. A machine tool including a fluid delivery system which includes the fluid mixing device of claim 1.

15. A computer-readable medium storing computer-executable instructions adapted to cause a 3D printer to print a fluid mixing device of claim 1.

16. An assembly comprising a fluid mixing device of claim 1 and a supporting tube for increasing resistance of the fluid mixing device to pressure exerted thereon by a fluid within the fluid mixing device, wherein the supporting tube defines an opening in which the fluid mixing device is located.
